(19) United States
(12) Patent Application Publication
(10) Pub. No.: US 2026/0267891 A1
(43) Pub. Date: Sep. 10, 2026

(54) METHOD AND DEVICE WITH HIERARCHAL ATTENTION OPERATION

(71) Applicant: SAMSUNG ELECTRONICS CO., LTD., Suwon-si (KR)

(72) Inventors: Hyewon MOON, Suwon-si (KR); Myeong Woo KIM, Suwon-si (KR); Seungwon LEE, Suwon-si (KR)

(73) Assignee: SAMSUNG ELECTRONICS CO., LTD., Suwon-si (KR)

(21) Appl. No.: 19/325,742

(22) Filed: Sep. 11, 2025

(30) Foreign Application Priority Data
Mar. 7, 2025 (KR) 10-2025-0030039

(51) Int. Cl. G06F 16/334; G06F 40/284

(52) U.S. Cl. CPC G06F 16/3347; G06F 40/284

(57) ABSTRACT

A processor-implement method including converting an input sequence to a sentence vector matrix, calculating a sentence-level attention score based on the sentence vector matrix, selecting, from among sentences of the input sequence, a sentence with the sentence-level attention score being greater than or equal to a threshold value, converting the selected sentence to a token vector matrix, and performing an attention operation based on the token vector matrix.

### CROSS-REFERENCE TO RELATED APPLICATIONS

This application claims the benefit under 35 USC § 119 (a) of Korean Patent Application No. 10-2025-0030039, filed on Mar. 7, 2025, in the Korean Intellectual Property Office, the entire disclosure of which is incorporated by reference herein for all purposes.

### BACKGROUND

### 1. Field

The following description relates to a method and device with a hierarchical attention operation.

### 2. Description of Related Art

With the development of natural language processing (NLP) technology, transformer-based models are being utilized in various applications. Transformer models learn relationships between elements in an input sequence through an attention mechanism, but there is an issue that the number of operations and memory usage increase rapidly as the length of an input length increases.

To solve this issue, various approaches to optimizing attention operations are being studied. For example, typical methods may try to reduce the number of operations by limiting an attention range or considering only relationships between predetermined tokens. However, these methods may result in information loss, so a new method is required that may maintain important information while increasing operational efficiency.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including converting an input sequence to a sentence vector matrix, calculating a sentence-level attention score based on the sentence vector matrix, selecting, from among sentences of the input sequence, a sentence with the sentence-level attention score being greater than or equal to a threshold value, converting the selected sentence to a token vector matrix, and performing an attention operation based on the token vector matrix.

The converting of the input sequence to the sentence vector matrix may include counting a number of sentences of the input sequence and converting the input sequence to the sentence vector matrix to perform a hierarchical attention operation responsive to the number of sentences being greater than or equal to a preset threshold number.

Each sentence may include a plurality of feature vectors, and the calculating of the sentence-level attention score may include calculating the sentence-level attention score using each of a plurality of representation vectors as an independent query.

The method may include setting a number of the plurality of feature vectors be less than an original number of tokens included in a corresponding sentence.

The converting of the input sequence to the sentence vector matrix may include converting the input sequence to the token vector matrix and obtaining the sentence vector matrix by applying a weight matrix to the token vector matrix.

The calculating of the sentence-level attention score may include generating a sentence-level query matrix based on the sentence vector matrix and calculating the sentence-level attention score based on the sentence-level query matrix.

The performing of the attention operation may include generating a token-level query matrix based on the token vector matrix, calculating a token-level attention score based on the token-level query matrix, and multiplying the token-level attention score by a value matrix.

In a general aspect, here is provided a non-transitory computer-readable storage medium storing instructions that, when executed by one or more processors, configure the one or more processors to convert an input sequence to a sentence vector matrix, calculate a sentence-level attention score based on the sentence vector matrix, select, from among sentences of the input sequence, a sentence with the sentence-level attention score being greater than or equal to a threshold value, convert the selected sentence to a token vector matrix, and perform an attention operation based on the token vector matrix.

In a general aspect, here is provided an electronic device including one or more processors including processing circuitry, a memory including one or more storage media storing instructions that, when executed individually or collectively by the one or more processors, cause the electronic device to convert an input sequence to a sentence vector matrix, calculate a sentence-level attention score based on the sentence vector matrix, select, from among sentences of the input sequence, a sentence with the sentence-level attention score being greater than or equal to a threshold value, convert the selected sentence to a token vector matrix, and perform an attention operation based on the token vector matrix.

The execution of the instructions may cause the electronic device to count a number of sentences of the input sequence and convert the input sequence to the sentence vector matrix to perform a hierarchical attention operation responsive to the number of sentences being greater than or equal to a preset threshold number.

Each sentence may include a plurality of feature vectors and the execution of the instructions may cause the electronic device to calculate the sentence-level attention score using each of a plurality of representation vectors as an independent query.

The execution of the instructions may cause the electronic device to set a number of the plurality of feature vectors is set to be less than an original number of tokens included in a corresponding sentence.

The execution of the instructions may cause the electronic device to convert the input sequence to the token vector matrix and obtain the sentence vector matrix by applying a weight matrix to the token vector matrix.

The execution of the instructions may cause the electronic device to generate a sentence-level query matrix based on the sentence vector matrix and calculate the sentence-level attention score based on the sentence-level query matrix.

The execution of the instructions may cause the electronic device to generate a token-level query matrix based on the token vector matrix, calculate a token-level attention score based on the token-level query matrix, and multiply the token-level attention score by a value matrix.

Other features and aspects will be apparent from the following detailed description, the drawings, and the claims.

### BRIEF DESCRIPTION OF THE DRAWINGS

FIG. 1 illustrates an example electronic device according to one or more embodiments.

FIGS. 2A and 2B illustrate example attention operations according to one or more embodiments.

FIG. 3 illustrates an example method with an attention operation according to one or more embodiments.

FIG. 4 illustrates an example method of extracting a core sentence according to one or more embodiments.

FIG. 5 illustrates an example method with a token-level attention operation between tokens of a core sentence according to one or more embodiments.

FIG. 6 illustrates an example of a typical token-level attention score matrix.

FIG. 7A illustrates an example process of converting an input sequence to a sentence vector matrix according to one or more embodiments.

FIG. 7B illustrates an example sentence-level attention score matrix according to one or more embodiments.

FIG. 7C illustrates an example attention score matrix of an extracted core sentence according to one or more embodiments.

FIG. 7D illustrates an example attention score matrix obtained with token-level attention score for sentences selected as core sentences according to one or more embodiments.

FIG. 8 illustrates an example method according to one or more embodiments.

Throughout the drawings and the detailed description, unless otherwise described or provided, it may be understood that the same drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

The examples may be implemented as various types of products such as, for example, a personal computer, a laptop computer, a tablet computer, a smart phone, a television, a smart home appliance, an intelligent vehicle, a kiosk, and a wearable device. Hereinafter, examples will be described in detail with reference to the accompanying drawings. In the drawings, like reference numerals are used for like elements.

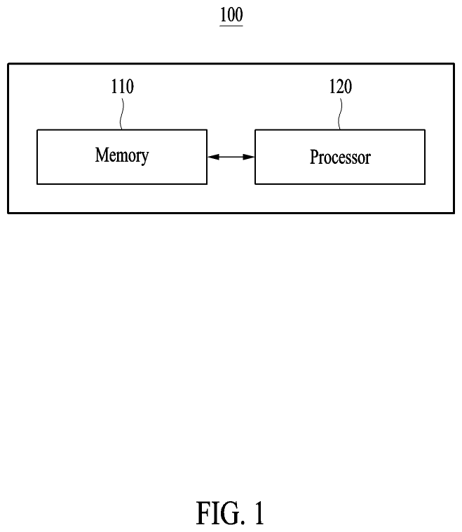

FIG. 1 illustrates an example electronic apparatus according to one or more embodiments.

An electronic device 100 may include hardware and software that processes an input sequence to perform an attention operation. For example, the electronic device 100 may be a computing device that may be implemented in various environments, such as a server, a cloud computing system, an artificial intelligence (AI) accelerator, a mobile device, an embedded system, an Internet of Things (IoT) device, and the like. The electronic device 100 may include a special-purpose hardware accelerator to optimize an attention operation or may be implemented as software by utilizing a general-purpose processor.

Referring to FIG. 1, in a non-limiting example, the electronic device 100 may include a memory 110 and a processor 120. The memory 110 may include computer-readable instructions. The processor 120 may be configured to execute computer-readable instructions, such as those stored in the memory 110, and through execution of the computer-readable instructions, the processor 120 may be configured to perform one or more, or any combination, of the operations and/or methods described herein.

That is, at least one instruction related to the electronic device 100 may be stored in the memory 110. An operating system (OS) for driving the electronic device 100 may be stored in the memory 110. Additionally, various software programs or applications for operating the electronic device 100 may be stored in the memory 110. Also, the memory 110 may include a semiconductor memory 110 such as flash memory 110 or a magnetic storage medium such as a hard disk.

Particularly, various software applications for operating the electronic device 100 may be stored in the memory 110, and the processor 120 may control an operation of the electronic device 100 by executing various software applications stored in the memory 110. That is, the memory 110 may be accessed by the processor 120, and data may be read, written, modified, deleted, and updated by the processor 120.

The term memory 110 may include the memory 110, read-only memory (ROM) (not shown) in the processor 120, random access memory (RAM) (not shown), or a memory 110 card (not shown) (e.g., a micro secure digital (SD) card or a memory 110 stick) mounted in the electronic device 100.

In particular, the memory 110 may store data on an artificial neural network model (e.g., a transformer model), input data, output data, data on an attention matrix, and the like.

In addition, necessary various information within the scope of achieving the purpose of the present disclosure may be stored in the memory 110. The information stored in the memory 110 may be updated as received from an external device or input by a user.

The processor 120 may be configured to execute programs or applications to configure the processor 120 to control the electronic device 100 to perform one or more or all operations and/or methods involving hierarchical attention operations, and may include one of an application specific integrated circuit (ASIC), an embedded processor, a microprocessor, hardware control logic, a hardware finite state machine (FSM), and a digital signal processor (DSP). Herein, the term processor 120 may include a central processing unit (CPU), a graphics processing unit (GPU), a microprocessor unit (MPU), and neural processing unit (NPU).

Additionally, the electronic device 100 may further include an input/output (I/O) interface (not shown). The I/O interface may be a device that allows the electronic device 100 to transmit and receive data to and from an external system. For example, when a network interface is included, a large language model (LLM) may be remotely executed via communication with a could server. Alternatively, when operating in a local environment, communication elements (e.g., an I/O interface) may receive a voice command of a user, a text input, and the like to perform an attention operation and provide the result back to the user.

The electronic device 100 may operate as an independent device or may operate as part of a cloud server to provide an AI service to a plurality of users.

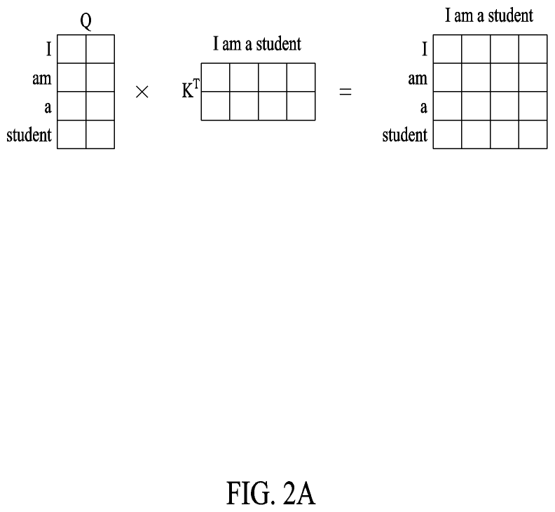

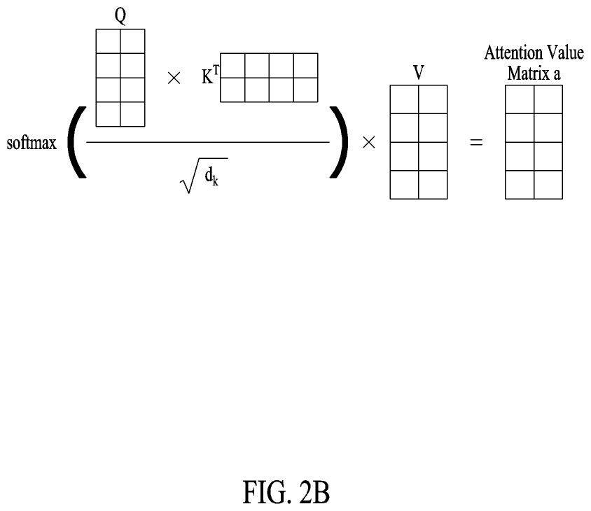

The electronic device 100 may be an operation device that may be used in various applications such as natural language processing (NLP), a search system, medical data analysis, a chatbot, and an AI accelerator by optimizing an attention operation. A method of optimizing an attention operation is described after an attention operation is described in greater detail below with reference to FIGS. 2A and 2B.

FIGS. 2A and 2B illustrate example attention operations according to one or more embodiments.

An attention operation may be an operation method that generates a final output by reflecting the importance of each element in an input sequence as a weight. The attention operation may be used in NLP and various deep learning applications, allowing each input element to learn relationships with other elements.

An input sequence may be a continuous data structure including sequential data (elements). The input sequence may include a set of individual elements, each of which may be arranged in a fixed order. The input sequence may be used in various fields such as NLP, speech recognition, image processing, and time series data analysis, and elements included in the input sequence may vary depending on the field. For example, the input sequence may be a continuous array of words or tokens in NLP, a continuous sample of speech signals in speech recognition, a continuous array of frames in image processing, or continuous numerical values over time in time series data. The input sequence may be generally represented as an embedding vector, and each input vector may have a fixed dimension.

Referring to FIG. 2A, in a non-limiting example, in order to perform an attention operation, a query matrix Q, a key matrix K, and a value matrix V may be obtained based on an input sequence. The query matrix Q, the key matrix K, and the value matrix V may be obtained by multiplying an input matrix corresponding to the input sequence by a learnable weight matrix. A weight matrix for generating a query, a key, and a value may be optimized during a model training process. The sizes of the query matrix Q, key matrix K, and value matrix V may vary depending on the number of input tokens and a model dimension.

An attention score matrix may be a matrix indicating how each input element is related to other elements. In an example, in Equation 1, the attention score matrix may be calculated by multiplying a transpose matrix of the query matrix Q by a transpose matrix of the key matrix K.

$$S = {QK}^{T} \qquad Equation l$$

In Equation 1, the query matrix Q may be a matrix of size N*d, K^{T} may be a matrix of size d*N, and S may be an attention score matrix of size N×N. N may denote the number of tokens appearing in the input sequence. For example, when the input sequence is “I am a student”, N=4 because the input sequence includes four words. Next, d may denote the number of dimensions (embedding dimension, hidden size) of a vector when each token is represented as a vector. When each token is converted to a 512-dimensional vector, d may be 512. For example, in the input sequence “I am a student” where each word is represented as a 512-dimensional vector, the size of an input vector matrix X may be X∈ [symbol] ^{4×512}, that is, a vector of four words (tokens)×512 dimensions.

When there is an input sentence such as “I am a student”, an attention score matrix may be calculated using a query vector and a key vector for each word, as illustrated in FIG. 2A. Each element in the attention score matrix may indicate how strongly a predetermined word is associated with other words.

Referring to FIG. 2B, in a non-limiting example, a process of calculating an attention value matrix using an attention score matrix is illustrated. An attention value matrix may include the final output that reflects a weight for an input vector. In an example, an attention score matrix may be normalized during an operation process and may be converted to a probability distribution when a softmax function is applied, as in Equation 2 below.

$$A = softmax ( \frac{S}{\sqrt{{d}_{k}}} ) \qquad Equation 2$$

In Equation 2, A may be a normalized attention weight matrix. In addition, dₖ may be the number of dimensions of a key vector, and a root value may be applied to the denominator for stability of an operation. In an example, the normalized attention weight matrix A may be multiplied by the value matrix V as in Equation 3 to calculate the final attention value matrix.

$$O = AV \qquad Equation 3$$

In Equation 3, O may be the final attention value matrix, A may be a matrix of size N×N, and V may be a matrix of size N×d. As a result, O may be a matrix of size N×d.

As illustrated in FIG. 2B, the normalized attention score matrix may be multiplied by the value matrix, and the final weighted sum output may be generated as each input vector reflects relationships with other vectors.

Recently, in a transformer-based LLM, lengths of the input sequences have been continuously expanded, and thus, predetermined models may be designed to process tens of thousands of tokens or more.

In a transformer-based model, an attention operation may account for the largest proportion of the total number of operations. As the length of an input sequence increases, the number of operations may increase in proportion to the square of the length of the input sequence. An attention operation may account for approximately 60% of the total number of model operations. That is, as an input sequence becomes longer, the number of operations and memory usage required for the attention operation may increase rapidly.

A typical attention operation may be performed on a token basis. In conventional technology, a method of tokenizing an input sequence, converting individual tokens to vectors, and then performing an attention operation may be generally used. However, as the length of the input sequence increases, the number of tokens generated also increases, which may increase the number of attention operations.

As the number of input tokens increases, the number of operations of a key-value (KV) cache, which is widely used in an inference process, may also increase. The KV cache is a technique for preventing unnecessary recalculation by storing previously calculated results, but as the length of an input sequence increases, the size of data to be stored and the number of operations may also increase. Therefore, it may be desired to optimize an attention operation as the sizes of input sequences increase.

As described in greater detail below, an example attention operation method may perform an attention operation by converting an input sequence to sentences, thereby optimizing the number of operations even in an environment in which the input sequence increases and maintaining performance while reducing the memory usage of a model.

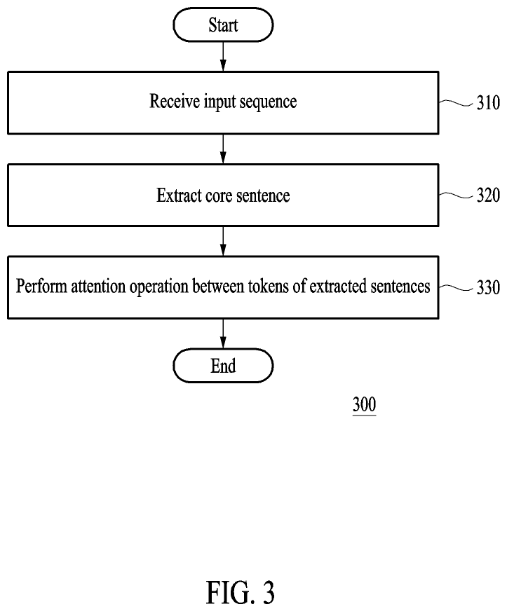

FIG. 3 illustrates an example method with an attention operation according to one or more embodiments. For ease of description, it is described that operations 310 to 330 are performed by the electronic device 100 illustrated in FIG. 1. However, operations 310 to 330 may be performed by another suitable electronic device in a suitable system.

Furthermore, the operations of FIG. 3 may be performed in the shown order and manner. However, the order of some operations may be changed, or some operations may be omitted, without departing from the spirit and scope of the shown example. In addition, the operations illustrated in FIG. 3 may be performed in parallel or simultaneously.

Referring to FIG. 3, in a non-limiting example, an attention operation 300 may be divided into three operations including operation 310 of receiving an input sequence, operation 320 of extracting a core sentence, and operation 330 of performing a token-level attention operation on the extracted sentence.

In an example, in operation 310 of receiving the input sequence, an electronic device (e.g., the electronic device 100 of FIG. 1) may receive data to be processed. The input sequence may be text data used in NLP and may include a predetermined document, a sentence, or a set of consecutive words. For example, news articles, papers, conversation data, and the like may be input. The input sequence may include individual tokens.

The electronic device may generate a sentence vector matrix, which is a new representation matrix, by converting the input sequence to a sentence level. The sentence vector matrix may be referred to as a sentence-level representation. In typical techniques, the size of a query matrix for one sentence may be N (number of tokens)×d (number of vector dimensions). However, when sentence-level conversion is employed, a sentence-level attention operation may be performed by defining a new Q_{new} matrix of size n (number of feature vectors)× d (number of vector dimensions). Here, N>>n, so the number of operations may be greatly reduced compared to typical techniques.

In an example, in operation 320 the core sentence may be extracted, and the electronic device may select predetermined sentences within the input sequence. A selection process may be performed based on the sentence-level attention operation. Not all input sentences are processed equally, but relatively important sentences may be emphasized. For example, it may be possible to reduce the number of operations by extracting a key sentence from a long document. The electronic device may calculate a sentence-level attention score based on a representation matrix obtained through sentence-level conversion and select a contextually important sentence based on the sentence-level attention score.

In an example, in operation 330 may include performing the token-level attention operation on the extracted sentence, converting core sentences to tokens, and performing an attention operation. In this process, the existing token-level attention operation may be performed and the relationship between each token may be learned to generate the final output.

When an attention operation is performed using only tokens of selected sentences, the overall number of operations may be significantly reduced. In addition, a technique for reducing the overall number of operations while maintaining information on an important token in a predetermined sentence may dynamically adjust a weight for a predetermined token in a sentence.

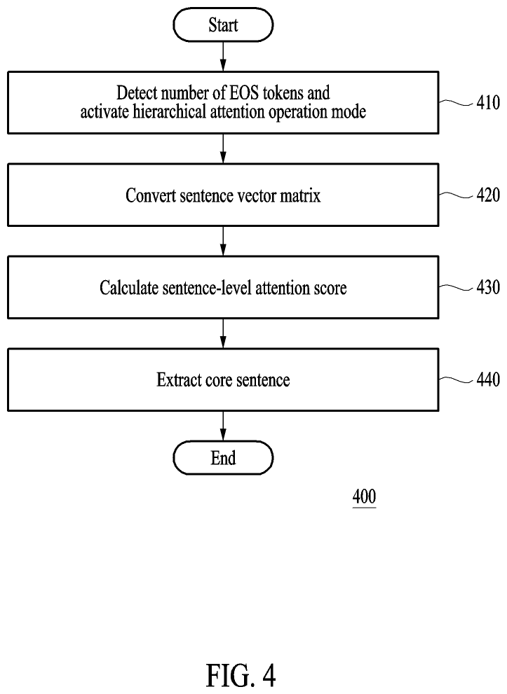

FIG. 4 illustrates an example method of extracting a core sentence according to one or more embodiments.

For ease of description, it is described that operations 410 to 440 are performed by the electronic device 100 illustrated in FIG. 1. However, operations 410 to 440 may be performed by another suitable electronic device in a suitable system.

Furthermore, the operations of FIG. 4 may be performed in the shown order and manner. However, the order of some operations may be changed or omitted without departing from the spirit and scope of the shown example. In addition, the operations illustrated in FIG. 4 may be performed in parallel or simultaneously.

Referring to FIG. 4, in a non-limiting example, method 400 may include operation 410 where an electronic device (e.g., the electronic device 100 of FIG. 1) may detect the number of predetermined tokens (e.g., end of sentence (EOS) tokens) and activate a hierarchical attention operation mode. An input sequence may include a plurality of sentences, and an individual sentence may include an EOS token. An EOS token may be a sentence boundary, and the electronic device may detect the number of EOS tokens to perform a sentence-level attention operation. When the number of EOS tokens is greater than or equal to a preset threshold value, the hierarchical attention operation mode may be activated. For example, when the input sequence includes a long document, the document may be divided into sentences and performing an attention operation on a sentence-by-sentence basis.

In an example, the hierarchical attention operation mode may reduce the number of operations compared to an existing token-level attention operation. In typical techniques, attention operations among all tokens may have to be performed after an input sequence is converted to individual tokens. However, when the hierarchical attention operation mode is activated, an attention operation may be performed based on a sentence-level vector matrix, so the number of operations may be reduced.

In an example, in operation 420, the electronic device may convert the input sequence to a sentence vector matrix. The electronic device may convert an input sentence to a vector matrix of a predetermined size to perform a sentence-level attention operation. In typical techniques, each sentence may be converted to individual tokens and token-level vectors may be generated. On the other hand, examples of the electronic device employing operation 420 may convert a sentence to a plurality of feature vectors instead of converting it to a single vector as in the typical techniques.

For example, when the size of the sentence vector matrix is 3×128, each sentence may be represented by three 128-dimensional vectors. For this, a plurality of feature vectors may be determined by applying a weight matrix. In this process, a weight matrix may be set as a learnable parameter and may be adjusted so that important token information may be reflected in a predetermined sentence.

In an example, in operation 430, the electronic device may calculate a sentence-level attention score. Once the sentence vector matrix is generated, a sentence-level attention score matrix may be calculated based on the sentence vector matrix. On the other hand, in typical techniques, an attention operation may be performed by considering relationships between all input tokens, but the present example electronic device may generate a sentence-level query matrix using a sentence vector matrix and then calculate a sentence-level attention score by performing a dot product operation between a sentence-level query matrix and a key matrix.

An attention score may indicate how highly related a predetermined sentence is to other sentences. For example, in a long document, when a sentence being considered is highly related to other sentences, the attention score of that sentence may increase. In addition, the attention score matrix may be used as a criterion for selecting a sentence in later operations.

In an example, in operation 440, the electronic device may extract a core sentence. The electronic device may select predetermined sentences based on the sentence-level attention score. In the selection process, it may be possible to determine whether the attention score of a predetermined sentence is greater than or equal to a preset threshold value. A sentence with a high attention score may be highly related to other sentences or may be more likely to have an important meaning across the entire document. Hereinafter, the selected predetermined sentences may be referred to as core sentences.

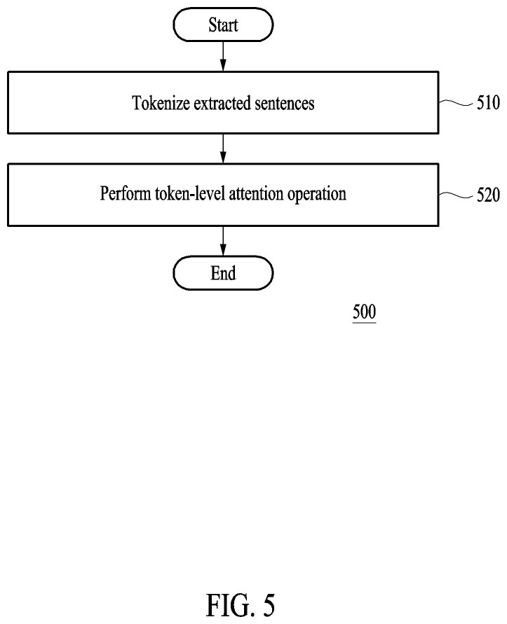

FIG. 5 illustrates an example method with a token-level attention operation between tokens of a core sentence according to one or more embodiments. For ease of description, it is described that operations 510 and 520 are performed by the electronic device 100 illustrated in FIG. 1. However, operations 510 and 520 may be performed by another suitable electronic apparatus in a suitable system.

Furthermore, the operations of FIG. 5 may be performed in the shown order and manner. However, the order of some operations may be changed or omitted without departing from the spirit and scope of the shown example. In addition, the operations illustrated in FIG. 5 may be performed in parallel or simultaneously.

Referring to FIG. 5, in a non-limiting example, method 500 may include operations 510 and 520. In an example, in operation 510, an electronic device may tokenize extracted sentences. In typical techniques, an attention operation may be performed after the entire input sequence is converted to tokens. However, in an attention operation method according to an example (e.g., method 500), a technique for first performing a sentence-level attention operation to select a core sentence and converting the core sentence to tokens may be employed.

In the process of tokenizing an extracted sentence, various tokenization techniques used in an existing natural language model may be employed. For example, a subword tokenization technique may be employed, which allows an input sentence to be divided into predetermined levels and processed.

In an example, in operation 520, the electronic device may perform a token-level attention operation. A tokenized sentence may be processed in the same way as an existing attention operation technique. The electronic device may embed each token to convert the embedded token to a fixed-dimensional vector and then generate query, key, and value matrices. Thereafter, the electronic device may perform the token-level attention operation according to Equations 1 to 3.

The hierarchical attention operation described with reference to FIGS. 4 and 5 may be configured to maintain important information in a document while reducing the number of operations compared to typical techniques that employ a token-level attention operation. In typical techniques, because relationships between all input tokens may have to be considered so that an operation is performed, the number of operations may increase in proportion to the square of the length of an input sequence as the length of the input sequence increases.

On the other hand, in examples of a hierarchical attention operation method (e.g., method 500), a vector may first be converted to a sentence level, then a sentence-level attention operation may be performed, and only an important sentence may be selected to perform a subsequent operation. Accordingly, when a long input sequence is processed in examples of the hierarchical attention operation method, the number of operations may be reduced, and contextually important information may be maintained.

For example, when an input document includes 500 sentences, and each sentence includes 30 tokens on average, a typical technique may result in an attention operation being performed on 500×30=15,000 tokens. However, in an example of method 400 of FIG. 4, when a sentence-level attention operation is first performed and then the number of important sentences is reduced to 400, the number of tokens to be processed in a subsequent operation may be reduced to 400×30=12,000.

In addition, during sentence-level vector conversion, when, instead of simply using the existing 30 token vectors, a weight matrix is applied to convert the existing 30 token vectors to three feature vectors, the size of a sentence vector matrix may be reduced to 3×128. This approach may be advantageous in maintaining important information while reducing the overall number of operations.

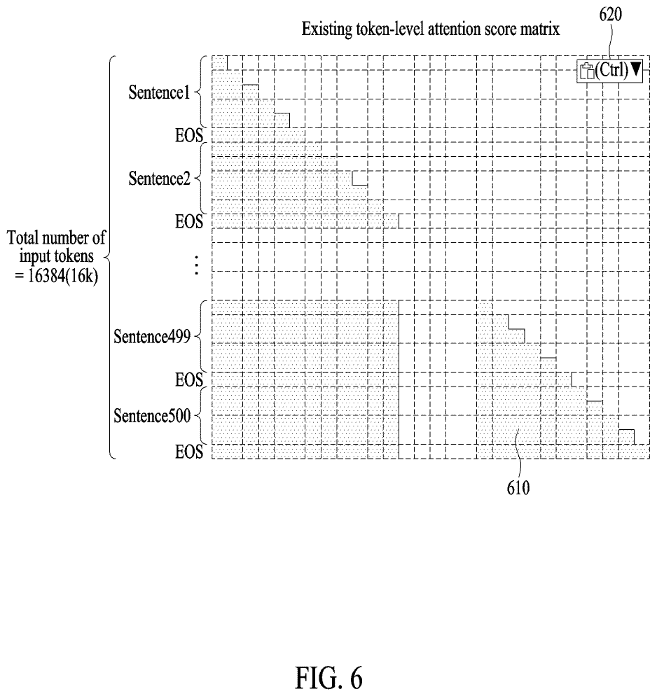

FIG. 6 illustrates an example of a typical token-level attention score matrix.

In a typical transformer-based attention operation, a technique for converting an input sequence to individual tokens and calculating relationships between tokens may be applied. In the method described in greater detail below with reference to FIG. 6, a query matrix and a key matrix may be generated based on the entire input sequence, and a dot product operation may be performed on corresponding matrices such that an attention score matrix may be calculated.

In the example shown in FIG. 6, the number of tokens in the entire input sequence may be 16,384, and the entire sequence may include a total of 500 sentences. Each sentence may include a predetermined number of tokens, and the end of a sentence may include an EOS token. In the typical technique as illustrated in FIG. 6, an individual attention score may be calculated for each of the 16,384 input tokens.

The sizes of query matrices and key matrices may each be 16,384×128. Here, 128 is the number of dimensions of a vector, and each token may be represented as a 128-dimensional vector. A dot product operation may be performed on a transpose matrix of a query matrix and a transpose matrix of a key matrix to calculate an attention score matrix. That is, the size of an existing attention score matrix may be 16,384×16,384, and the total number of operations may be calculated as 16,384×128×16,384=34,359,738,368.

The number of operations may be significantly large because an attention operation is required to be performed on every input token. Since typical techniques may use a technique for calculating an attention matrix by considering all input tokens, the number of operations may increase in proportion to the square of the length of an input sequence as the length of the input sequence increases. For example, when the length of the input sequence doubles, the amount of attention computation may quadruple.

Referring to the attention score matrix illustrated in FIG. 6, an operation may be performed only on a first region 610, and an operation may not be performed on a second region 620. The second region 620 may be a masked region.

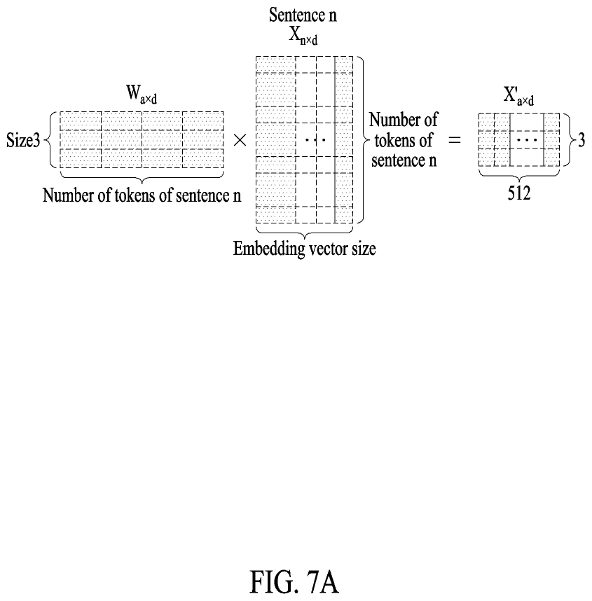

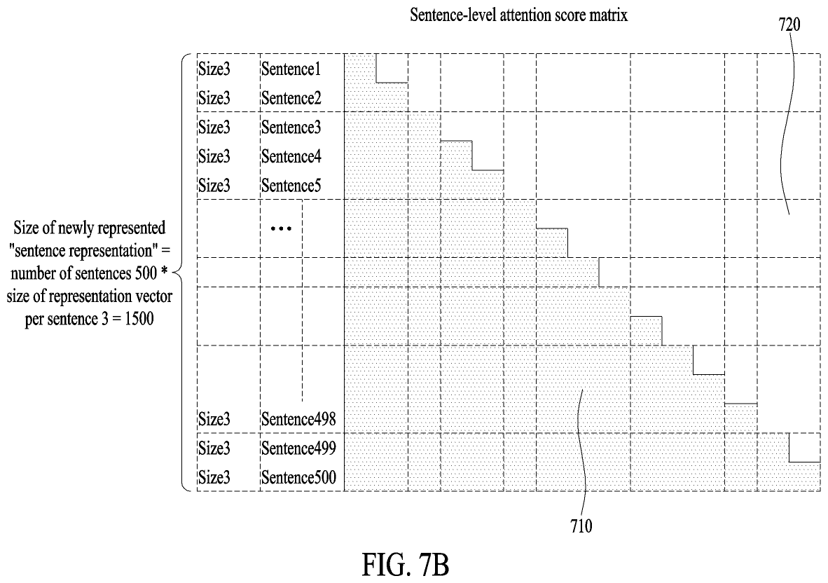

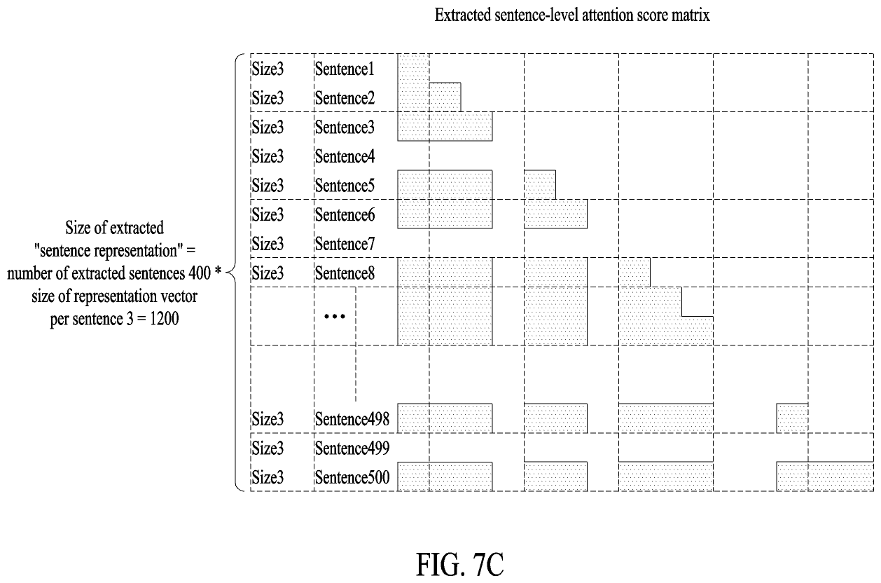

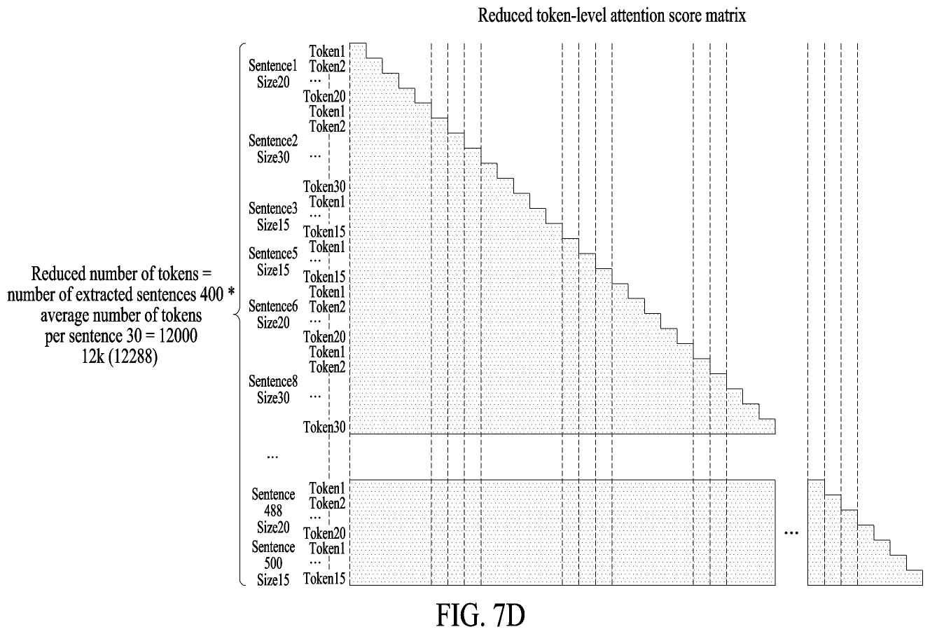

FIG. 7A illustrates an example process of converting an input sequence to a sentence vector matrix according to one or more embodiments. In typical token-based attention operations, a technique for converting an input sequence to individual tokens and generating a vector representation for each token is used.

Referring to FIG. 7A, in a non-limiting example, a method of converting an input sentence to a vector matrix to generate a sentence-level representation is illustrated.

In the example illustrated in FIG. 7A, a sentence may include a plurality of tokens, and each token may be converted to an embedding vector. For example, it may be assumed that a sentence may include an average of 30 tokens and that each token may be converted to a 512-dimensional vector. However, the number of tokens included in a sentence and the number of dimensions of vectors included in each token are not limited to the example described above. An electronic device may configure all token embeddings of a sentence into a single matrix to generate a sentence-level vector matrix and represent a corresponding matrix as X_{n×d}. Here, n may represent the number of tokens in a sentence, and d may represent the dimension of an embedding vector.

In the process of generating a sentence vector matrix, a predetermined weight matrix may be applied. In FIG. 7A, a weight matrix W_{a×d} may be used to extract a sentence representation. In addition, a may represent the number of vectors representing each sentence (hereinafter, representative vectors). For example, in the example of FIG. 7A, a may be set to 3, which may indicate that one sentence is converted to three vectors.

The weight matrix may be set as a learnable parameter, and a sentence-level vector matrix may be generated by performing a dot product operation with an embedding matrix of an input sentence. In this process, it may be possible to perform a more efficient operation by compressing a sentence while maintaining the entire meaning and/or information of the sentence.

In an example, a process of applying a weight matrix may be defined by Equation 4.

$$W = {UX}^{T} + b \qquad Equation 4$$

In Equation 4, X∈ [symbol] ^{n×d} may be a vector matrix of tokens included in a sentence, W may be a weight matrix, U may be a learnable matrix, and b may be a bias matrix. According to Equation 4, the electronic device (e.g., electronic device 100) may convert an input sentence to a predetermined number of representative vectors, thereby reducing the number of operations and maintaining important information of the sentence.

It may be possible to generate a final sentence vector matrix

$${X}_{a \times d}^{′}$$

by converting a sentence by applying a weight matrix. In the example illustrated in FIG. 7A, each sentence may be converted to three representative vectors, and the size of each vector may be set to 512. That is, the size of the final sentence vector matrix may be 3×512. In typical techniques, individual operations need to be performed on all tokens included in a sentence, but in the example described with reference to FIG. 7A (e.g., method 400), a sentence may be converted to a vector matrix of a predetermined size such that the number of operations is reduced.

The number of operations in the example described above may be analyzed, and the number of operations required in a sentence-level vector conversion process may be (30×512×3)×2=92,160. This may include an operation performed to convert a token vector of each sentence to three representative vectors. When there are 500 sentences in total, the total number of operations may be 92,160×500=46,080,000 which is significantly fewer operations than the number of operations required in the typical technique illustrated above with respect to FIG. 6.

FIG. 7B illustrates an example sentence-level attention score matrix according to one or more embodiments.

In FIG. 7A, after an input sequence is converted to a sentence vector matrix, the electronic device may calculate an attention score to perform a sentence-level attention operation.

In typical techniques, an attention operation needs to be performed on each token to calculate an attention score matrix of size 16,384×16,384, but in FIG. 7B, a smaller attention matrix may be calculated using vectors converted to sentences.

After converting all input sentences to a predetermined number of vectors, the electronic device may perform a sentence-level attention operation based on the converted vectors. The example illustrated in FIG. 7B may include a total of 500 sentences, and each sentence may be represented by three feature vectors. Therefore, the total number of sentence representation vectors may finally be 500×3=1,500. It may be possible to generate a query matrix and a key matrix based on a sentence vector matrix to calculate a sentence-level attention score matrix. The size of each of the query matrix and the key matrix may be 1,500×128, so the number of operations required to perform a sentence-level attention score matrix operation may be 1,500×128×1,500=288,000,000, and the size of the final sentence-level attention score matrix may be 1,500×1,500.

Referring to the attention score matrix illustrated in FIG. 7B, in a non-limiting example, an operation may be performed only on a first region 710, and an operation may not be performed on a second region 720. The second region 720 may be a masked region.

An attention score matrix is a matrix that numerically represents how each sentence is related to other sentences, and an attention score for a predetermined sentence may include a set of values representing relationships between a corresponding sentence and all other sentences. For example, in FIG. 7B, the attention score of sentence 1 may be a vector that quantitatively represents relationships between sentence 1 and other sentences. Particularly, the attention score vector of sentence 1 may be defined by Equation 5.

$${S}_{1} = [ {S}_{1 , 1} , {S}_{1 , 2} , {S}_{1 , 3} , … , {S}_{1 , 500} ] \qquad Equation 5$$

In Equation 5, S_{1,j} may be a numerical value indicating the degree of the attention relationship between sentence 1 and sentence j. In other words, the attention score row of sentence 1 may be a vector that includes all the relationships that sentence 1 has with not only sentence 1 itself but also sentence 2, sentence 3, . . . , sentence 500. A sentence-level attention score matrix may be used to determine how important a predetermined sentence is within a document or what other sentences are related to a predetermined sentence.

In order to extract a core sentence, an attention score vector per sentence may be converted to a single representative value and then evaluated. For example, the electronic device may calculate the average value of the attention score vectors of sentence 1 and select sentence 1 as a core sentence when the average value is greater than or equal to a predetermined threshold value. Alternatively, the electronic device may determine whether sentence 1 is a core sentence by selecting the highest value among the attention relationships that sentence 1 has with other sentences. Alternatively, the electronic device may determine a core sentence based on an attention score with respect to a predetermined reference sentence. However, the method of converting an attention score vector per sentence to a single representative value is not limited to the example described above. The electronic device may determine a corresponding sentence as a core sentence when a calculated representative value is greater than or equal to a preset threshold value.

FIG. 7C illustrates an example attention score matrix of an extracted core sentence according to one or more embodiments.

Referring to FIG. 7C, in a non-limiting example, 400 sentences out of 500 sentences may be extracted as core sentences, and the remaining 100 sentences may be excluded from an operation process. For example, sentences such as sentence 4, sentence 7, and sentence 499 may be excluded from the core sentences. The sentences selected as core sentences may be considered more important information when an attention operation is performed.

The size of a sentence-level attention matrix may be determined by the number of extracted sentences and the number of sentence vectors. In the example of FIG. 7C, the number of extracted sentences is 400, and each sentence may be represented by three vectors (feature vectors), so the final number of sentence vectors may be 400×3=1,200.

FIG. 7D illustrates an example attention score matrix obtained with token-level attention score for sentences selected as core sentences according to one or more embodiments.

Referring to FIG. 7D, in a non-limiting example, sentences selected as core sentences may be tokenized and then converted to individual tokens. In the example of FIG. 7D, the number of core sentences is 400, and the total number of tokens is reduced to 12,288. Therefore, token-level attention operations for the core sentences may be performed on 12,288 tokens. Thus, the number of operations required in a token-level attention score operation process may be 12,288×128×12,288=19,327,352,832.

Referring to FIG. 7A, the number of operations required to calculate a sentence-level attention score is 1500×128×1500=288,000,000, so the total number of operations in a hierarchical attention operation may be 288,000,000+19,327,352,832=19,615,352,832. Referring to FIG. 6, the number of operations of the existing token-level attention score operation is 16,384×128×16,384=34,359,738,368, so the number of operations reduced compared to the existing number of operations may be 34,359,738,368-19,615,352,832=16,014,196,736, and thus, a rate of reduction in the number of operations may be 46.6%.

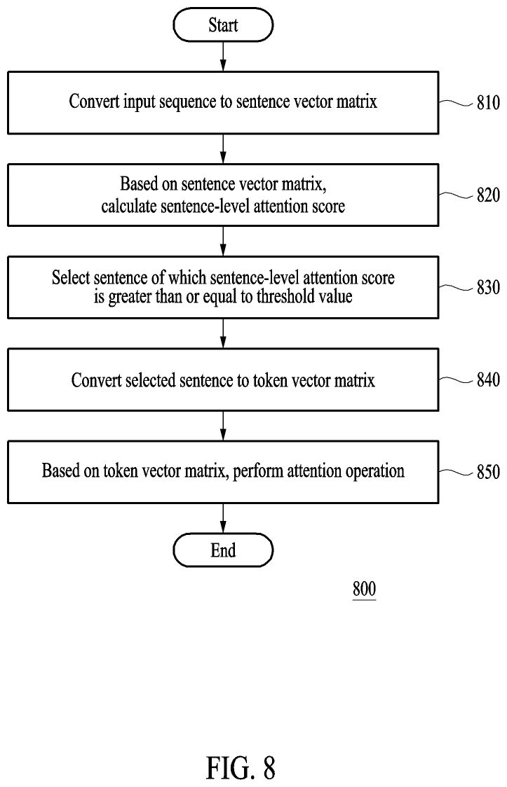

FIG. 8 illustrates an example method according to one or more embodiments.

For ease of description, it is described that operations 810 to 850 are performed by the electronic device 100 illustrated in FIG. 1. However, operations 810 to 850 may be performed by another suitable electronic apparatus in a suitable system.

Furthermore, the operations of FIG. 8 may be performed in the shown order and manner. However, the order of some operations may be changed, or some operations may be omitted, without departing from the spirit and scope of the shown example. In addition, the operations illustrated in FIG. 8 may be performed in parallel or simultaneously.

Referring to FIG. 8, in a non-limiting example, method 800 may include operations 810 to 850. In an example, in operation 810, an electronic device may convert an input sequence to a sentence vector matrix. The electronic device may count the number of sentences in the input sequence and, when the number of sentences is greater than or equal to a preset threshold number, may convert the input sequence to a sentence vector matrix to perform a hierarchical attention operation. Each sentence may include a plurality of feature vectors. The number of the plurality of feature vectors may be set to be less than the original number of tokens included in a corresponding sentence. The electronic device may convert the input sequence to a token vector matrix and obtain the sentence vector matrix by applying a weight matrix to the token vector matrix.

In an example, in operation 820, the electronic device may calculate a sentence-level attention score based on the sentence vector matrix. The electronic device may calculate the sentence-level attention score using each of a plurality of representation vectors as an independent query. The electronic device may generate a sentence-level query matrix based on the sentence vector matrix and calculate the sentence-level attention score based on the sentence-level query matrix.

In an example, in operation 830, the electronic device may select a sentence of which the sentence-level attention score is greater than or equal to a threshold value.

In an example, in operation 840, the electronic device may convert the selected sentence to a token vector matrix.

In an example, in operation 850, the electronic device may perform an attention operation based on the token vector matrix. The electronic device may generate a token-level query matrix based on the token vector matrix, calculate a token-level attention score based on the token-level query matrix, and perform an operation of multiplying the token-level attention score by a value matrix.

The electronic devices, neural networks, memory, processors, electronic device 100, memory 110, and processor 120, described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
converting an input sequence to a sentence vector matrix;
calculating a sentence-level attention score based on the sentence vector matrix;
selecting, from among sentences of the input sequence, a sentence with the sentence-level attention score being greater than or equal to a threshold value;
converting the selected sentence to a token vector matrix; and
performing an attention operation based on the token vector matrix.

2. The method of claim 1, wherein the converting of the input sequence to the sentence vector matrix comprises:
counting a number of sentences of the input sequence; and
converting the input sequence to the sentence vector matrix to perform a hierarchical attention operation responsive to the number of sentences being greater than or equal to a preset threshold number.

3. The method of claim 1, wherein each sentence comprises a plurality of feature vectors, and
wherein the calculating of the sentence-level attention score comprises:
calculating the sentence-level attention score using each of a plurality of representation vectors as an independent query.

4. The method of claim 3, further comprising:
setting a number of the plurality of feature vectors be less than an original number of tokens comprised in a corresponding sentence.

5. The method of claim 1, wherein the converting of the input sequence to the sentence vector matrix comprises:
converting the input sequence to the token vector matrix; and
obtaining the sentence vector matrix by applying a weight matrix to the token vector matrix.

6. The method of claim 1, wherein the calculating of the sentence-level attention score comprises:
generating a sentence-level query matrix based on the sentence vector matrix; and
calculating the sentence-level attention score based on the sentence-level query matrix.

7. The method of claim 1, wherein the performing of the attention operation comprises:
generating a token-level query matrix based on the token vector matrix;
calculating a token-level attention score based on the token-level query matrix; and
multiplying the token-level attention score by a value matrix.

8. A non-transitory computer-readable storage medium storing instructions that, when executed by one or more processors, configure the one or more processors to:
convert an input sequence to a sentence vector matrix;
calculate a sentence-level attention score based on the sentence vector matrix;
select, from among sentences of the input sequence, a sentence with the sentence-level attention score being greater than or equal to a threshold value;
convert the selected sentence to a token vector matrix; and
perform an attention operation based on the token vector matrix.

9. An electronic device, comprising:
one or more processors comprising processing circuitry; and
a memory comprising one or more storage media storing instructions that, when executed individually or collectively by the one or more processors, cause the electronic device to:
convert an input sequence to a sentence vector matrix;
calculate a sentence-level attention score based on the sentence vector matrix;
select, from among sentences of the input sequence, a sentence with the sentence-level attention score being greater than or equal to a threshold value;
convert the selected sentence to a token vector matrix; and
perform an attention operation based on the token vector matrix.

10. The electronic device of claim 9, wherein the execution of the instructions causes the electronic device to:
count a number of sentences of the input sequence; and
convert the input sequence to the sentence vector matrix to perform a hierarchical attention operation responsive to the number of sentences being greater than or equal to a preset threshold number.

11. The electronic device of claim 9, wherein each sentence comprises a plurality of feature vectors, and
wherein the execution of the instructions causes the electronic device to:
calculate the sentence-level attention score using each of a plurality of representation vectors as an independent query.

12. The electronic device of claim 11, wherein the execution of the instructions causes the electronic device to:
set a number of the plurality of feature vectors is set to be less than an original number of tokens comprised in a corresponding sentence.

13. The electronic device of claim 9, wherein the execution of the instructions causes the electronic device to:
convert the input sequence to the token vector matrix; and
obtain the sentence vector matrix by applying a weight matrix to the token vector matrix.

14. The electronic device of claim 9, wherein the execution of the instructions causes the electronic device:
generate a sentence-level query matrix based on the sentence vector matrix; and
calculate the sentence-level attention score based on the sentence-level query matrix.

15. The electronic device of claim 9, wherein the execution of the instructions causes the electronic device to:
generate a token-level query matrix based on the token vector matrix;
calculate a token-level attention score based on the token-level query matrix; and
multiply the token-level attention score by a value matrix.
